(19) United States
(12) Patent Application Publication
(10) Pub. No.: US 2005/0069480 A1
(43) Pub. Date: Mar. 31, 2005

(54) Ultrasonic reflux system for one-step purification of carbon nanostructures

(76) Inventors: Houjin Huang, Kanagawa (JP); Masashi Shiraishi, Tokyo (JP); Atsuo Yamada, Kanagawa (JP); Hisashi Kajiura, Kanagawa (JP); Masafumi Ata, Kanagawa (JP)

Correspondence Address: BELL, BOYD & LLOYD, LLC, P. O. BOX 1135, CHICAGO, IL, 60690-1135, US

(21) Appl. No.: 10/433,125

(22) PCT Filed: Dec. 7, 2001
(86) PCT No.: PCT/JP01/10713

(30) Foreign Application Priority Data
Dec. 8, 2000 (JP) 2000-375043

(51) Int. Cl. D01F 9/12; B01D 3/14

(52) U.S. Cl. 423/447.1; 423/461; 202/161; 202/168; 202/169; 202/170

(57) ABSTRACT

Reflux systems and methods for purifying carbon nanostructures using same are provided. The reflux system includes a solvent flask, an extraction tube connected to the solvent flask by a siphon tube and a vapor tube each extending between the extraction tube and the solvent flask, and an energy application disposed around the bottom portion of the extraction tube. The reflux systems can be used in a one-step method of purifying carbon nanostructures that includes placing a soot sample that contains the carbon nanostructures and amorphous carbon in a filter and disposing the filter in the extraction tube.

### CROSS REFERENCES TO RELATED APPLICATIONS

The present application claims priority to Japanese Patent Document No. 2000-375043 filed on Dec. 8, 2000, the disclosure of which is incorporated herein by reference.

### BACKGROUND OF THE INVENTION

The present invention relates to a reflux systems, and methods, for purifying carbon nanostructures. More particularly, the present invention relates to improved apparatusses and systems and methods of using same to purify carbon nanostructures, including single wall nanotubes (SWNTs), multi-wall nanotubes (MWNTs), fullerenes, endohedral metallofullerenes, carbon nanofibers, and other carbon-containing nano-materials. The reflux systems and methods are particularly useful for purifying SWNTs.

One known method of purifying carbon nanostructures includes baking a soot sample at 750° C. in air for about thirty minutes. See “Purification of nanotubes” by Ebbesen et al, Nature, vol. 367, 10 February 1994, p. 519. However, Ebbesen's method is directed to the purification of MWNTs; such high heat in this process tends to damage, or even destroy, SWNTs.

Other known methods of purifying carbon nanostructures involve multiple steps carried out in multiple apparatuses. See “Purification Procedure for Single-Walled Nanotubes” by K. Tohji et al., J. Phys. Chem. B, vol. 101, 1997, p. 1974-1978, for example. That is, soot produced by arc-discharge includes many byproducts such as metal particles, fullerenes, buckyonions, and a large amount of amorphous carbon together with the desired SWNTs. Thus, heretofore, many steps carried out in multiple apparatuses have been necessary for purifying SWNTs. The steps typically include, for example, hydrothermally initiated dynamic extraction (HIDE), sonication, filtration, drying, washing, heat treatment, and acid treatment. But many of the processes are performed in different apparatuses, thereby necessitating removal of the soot sample from one apparatus and placing it in another apparatus.

Still other known methods include microfiltration, and some even use ultrasound to assist in the filtration. See “Purification of single-wall carbon nanotubes by ultrasonically assisted filtration” by Konstantin B. Shelimov et al., Chem. Phys. Lett., vol. 282, 1998, p. 429-434, for example. In such methods, however, multiple steps are still necessary, and the yield remains low. That is, the soot is first suspended in toluene and filtered to extract soluble fullerenes. Then, the toluene-insoluble fraction is re-suspended in methanol and filtered with assistance of an ultrasonic horn inserted into the filtration funnel. Finally, a separate acid wash is performed to remove metal particles. Therefore, because of the many steps and apparatuses necessary, these methods have been implemented mainly for diluted and relatively pure raw materials such as those synthesized by laser ablation; they are inefficient for large quantities of low-purity raw materials.

Lastly, a dilute nitric acid reflux technique has been performed to purify SWNTs. See “A Simple and Complete Purification of Single-Walled Carbon Nanotube Materials”, by Anne C. Dillon et al., Advanced Materials 1999, vol. 11, no. 16, p. 1354-1358. But this process still requires three steps—including an oxidation step in which the carbon is heated to 550° C.—carried out in different apparatuses. Therefore, this process suffers the same drawbacks as like processes discussed above. Namely, the different steps require transference of the soot, the heating step damages or destroys SWNTs, and the method is effective only for high-purity soot.

Because the related art purification methods include multiple steps, performed in multiple apparatuses, these methods are time consuming and labor intensive. Additionally, there is risk that some of the sample is lost, contaminated, or destroyed in transit from one apparatus to another. Further, because of the large amount of amorphous carbon in the soot samples, and the heating steps, these methods have only been able to achieve a low yield (about 5 wt %) of 95% pure SWNTs.

### SUMMARY OF THE INVENTION

The present invention relates to improved reflux systems and methods for purifying carbon nanostructures. For example, the present invention can avoid using heat, especially high heat, to purify carbon nanostructures because such high heat tends to damage the carbon nanostructures. In fact, high heat tends to destroy SWNTs altogether, whereas it merely tends to burn off the outer layers of MWNTs.

The present invention can provide methods and apparatuses that are useful for purifying large quantities of low-purity raw materials, such as those synthesized by arc-discharge. The present invention can also purify such materials in a highly efficient manner which yields a high percentage of the desired carbon nanostructures.

Still further, the present invention can provide apparatuses and methods that are simple and less complex in design and construction by which various forms of carbon nanostructures can be purified. That is, the present apparatus and method can be used to purify carbon nanotubes, extract fullerenes, or both, from a given soot sample.

In order to avoid using heat to purify carbon nanostructures, the present invention is carried out at ambient, or room temperature according to an embodiment. When purifying carbon nanotubes, an oxidizing gas is introduced into the soot sample in order to oxidize the amorphous carbon therein, and a solvent is used to remove the oxidized amorphous carbon. When purifying fullerenes, the amorphous carbon is not oxidized but, instead, a solvent is used to remove the fullerenes from the soot sample. In any case, because the carbon nanostructures are purified at ambient temperature, they are not damaged by high heat. Further, the use of little, or no, heat leads to an increased yield of carbon nanostructures, especially SWNTs, because the carbon nanostructures are not destroyed in the purification process.

In order to avoid transferring the soot sample between apparatuses, thereby reducing the time required for purification as well as reducing the risk of contaminating or damaging a sample, the methods of the present invention can be performed in a single apparatus. That is, the soot sample and products separated therefrom can remain in one apparatus until the desired structures are purified. Further, because the present invention does not require soot transference, it is less labor intensive and, therefore, less costly.

In order to increase the yield of the desired carbon nanostructure specially SWNTs—from low-purity raw materials, the present method and apparatus use a one-step process in an embodiment. In the one-step process, amorphous carbon is oxidized, oxidized amorphous carbon is removed, and metallic particles are removed, in a short period of time because these processes are carried out by the same apparatus. Additionally, the processes can be performed simultaneously thereby further increasing the speed of the process. Moreover, energy—such as ultrasonic vibrations, or microwaves, for exampl—can be used to assist in dispersing agglomerations thereby making more of the soot sample available to the other processes and, hence, make the process more efficiently attain a higher yield. The ultrasonic energy is applied with the soot remaining in the same apparatus, and may be applied at the same time as the other processes, thereby reducing the time necessary to purify the sample. Because the time for purification is reduced, a relatively large, low-purity, sample efficiently can be purified.

A reflux system including a solvent flask, an extraction tube connected to the solvent flask by a siphon tube and a vapor tube each extending between the extraction tube and the solvent flask, and an energy applicator disposed around the bottom portion of the extraction tube is provided pursuant to an embodiment of the present invention. Further, a condenser is connected to the top portion of the extraction tube. A supply tube is connected to the extraction tube, whereby material can be introduced into the extraction tube. The reflux system is used in a one-step method, of purifying carbon nanostructures, including placing a soot sample—containing the carbon nanostructures and amorphous carbon—in a filter and disposing the filter in the extraction tube. Solvent is then introduced into the extraction tube so as to collect in the lower portion thereof, and remove one of the amorphous carbon and the carbon nanostructures from the soot. Further, the energy applicator is used to apply ultrasonic vibrations to the soot so as to disperse agglomerations therein. The solvent, and the one of the amorphous carbon and carbon nanostructures dissolved therein, is then removed from the extraction tube so that the other one of the amorphous carbon and the carbon nanostructures remains in the filter. Further, the method is performed at ambient temperature, an oxidizing gas is introduced into the extraction tube to oxidize the amorphous carbon, and acid is introduced into the extraction tube to remove metallic particles from the soot.

Additional features and advantages of the present invention are described in, and will be apparent from, the following Detailed Description of the Invention and the figures.

### BRIEF DESCRIPTION OF THE FIGURES

FIG. 1 is a schematic, partial cross sectional, view showing a reflux system according to an embodiment of the present invention.

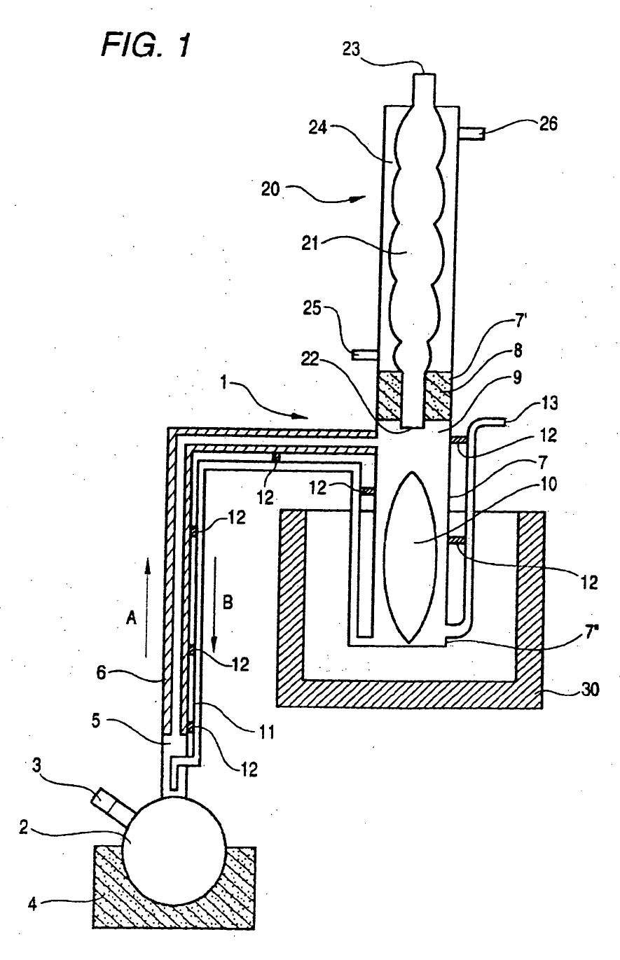

### DETAILED DESCRIPTION OF THE INVENTION

The present invention generally relates to reflux systems and methods for purifying carbon nanostructures.

The reflux system of the present invention in an embodiment allows carbon nanostructures to be purified in one step by filtration, extraction, or both, carried out at ambient temperature. That is, soot containing the desired carbon nanostructures as well as unwanted byproducts is put into a filter, is placed into the reflux system and, through various processes performed in the reflux system, the desired carbon nanostructures are removed from the reflux system. Therefore, neither the soot, nor any intermediate products, need be removed from the reflux system until the purification process is complete; the entire purification process takes place within the reflux system and takes place at ambient temperature. The reflux system includes an extractor 1, a condenser 20, and an energy applicator 30.

The extractor 1 includes a solvent flask 2, a thermal mantle 4, and an extraction tube 7. The solvent flask 2 sits in the thermal mantle 4 so as to be heated thereby. The thermal mantle 4 is configured so that it can produce a variable amount of heat for evaporating various solvents held within the solvent flask 2. Additionally, the solvent flask 2 has a flask inlet 3 through which solvent, and gases, can be introduced into the flask 2. A vapor tube 5 and a siphon tube 11 are connected between the solvent flask 2 and the extraction tube 7, so that the solvent flask 2 and extraction tube 7 are in communication with one another.

The extraction tube 7 includes a top portion 7′ and a bottom portion 7″. A stopper 8 is disposed in the extraction-tube top portion 7′ so as to form a vapor chamber 9 in the extraction tube 7. The vapor tube 5 is connected to the extraction tube 7 so as to be in communication with the vapor chamber 9, whereas the siphon tube 11 is connected to the bottom portion 7″ of the extraction tube 7. Spacers 12 are disposed between the vapor tube 5 and the siphon tube 11, as well as between the siphon tube 11 and the extraction tube 7. Additionally, a supply tube 13 is connected to the bottom portion 7″ of the extraction tube 7. The supply tube 13 allows material, in particular gases used during a filtration process, to be introduced into the extraction tube 7. Spacers 12 are also disposed between the supply tube 13 and the extraction tube 7. The extraction tube 7 is sized and configured to hold a filter 10 therein. The filter 10 initially holds the sample to be purified and, after the purification process, holds the undissolved portion of the sample.

The condenser 20 is connected to the upper portion 7′ of the extraction tube 7 so as to receive vapors from the vapor chamber 9. More particularly, the condenser 20 includes a condenser tube 21 having a condenser-tube inlet 22 and a condenser-tube gas outlet 23. The condenser-tube inlet 22 is connected to the stopper 8 so as to communicate with the vapor chamber 9. The condenser-tube gas outlet 23 allows some gases to escape from the top of the condenser tube 21. Further, the condenser tube 21 includes a cooling-fluid jacket 24 having a cooling-fluid inlet 25 and a cooling-fluid outlet 26.

The energy applicator 30 is disposed about the bottom portion 7″ of the extraction tube 7 so as to apply energy to a sample disposed in filter 10. The energy applicator 30 can be, for example, an ultrasonic vibrator, or a microwave applicator. The energy applicator 30 assists in dispersing agglomerations in the sample disposed in filter 10 so that the sample is more easily, and thoroughly, purified. That is, the energy applicator 30 allows the apparatus to achieve a higher purity, higher yield, of desired product from the sample.

A general purification process, using the above-described reflux system, will now be described according to an embodiment of the present invention.

First, a sample to be purified is placed in the filter 10 which, in turn, is disposed within the extraction tube 7. A solvent, for removing the soluble portion of the sample, is disposed in the solvent flask 2 wherein it is heated so as to evaporate. The evaporated solvent enters evaporation tube 5, which is insulated by vapor-tube insulation 6 so as to maintain the solvent in its evaporated state as it travels through the evaporation tube 5. The evaporated solvent then travels through the evaporation tube 5, along the direction of arrow A, so as to enter the vapor chamber 9. In order to assist in driving the evaporated solvent through the evaporation tube 5, gas may be pumped through the flask inlet 3. After driving the evaporated solvent to the evaporation chamber 9 and, subsequently, to the condenser tube 21, the gas is allowed to exit through the condenser-tube gas outlet 23.

Vapor from vapor chamber 9 enters the condenser-tube inlet 22 and passes up through the condenser tube 21, wherein it is condensed. The condensate then falls back through the condenser-tube inlet 22 and down onto the filter 10 disposed in the extraction tube 7. The condensate collects in the extraction tube 7 and enters the filter 10 so as to react with the soluble portion of the sample contained therein. When the solvent level in the extraction tube 7 rises above the highest portion of the siphon tube 11, the solvent then flows through the siphon tube 11, in the direction of arrow B, back down into the solvent flask 2 carrying the soluble portion of the sample with it. Because the siphon tube 11 is connected to the bottom portion 7″ of the extraction tube 7, substantially all of the solvent—including soluble portions of the sample dissolved therein—are removed from the extraction tube 7.

The evaporation process is again carried out as necessary, so that the soluble portion of the sample is collected in the solvent flask 2. That is, the temperature of the thermal mantle is selected so that only the solvent, not the soluble portion of the sample, is evaporated from the solvent flask 2.

In order to assist with separating the desired portion of the sample from the impurities, gases or other materials may be introduced into the extraction tube 7 through supply tube 13. Generally, gase—such as oxidizing gases, acid vapor and the like—will be introduced and, therefore, the supply tube 13 is connected to the bottom portion 7″ of the extraction tube 7 so that the gasses flow up through the filter 10 and through the sample contained therein. Further, any unused portion of the gases introduced through the supply tube 13 are allowed to exit through the condenser-tube gas outlet 23. Although the supply tube 13 preferably is connected to the bottom portion 7″, it can be connected anywhere along the extraction tube 7, especially if liquids are to be introduced therethrough.

To further assist with separating the desired portion of the sample from the impurities, the energy applicator 30 may be used to apply energy to the sample contained in filter 10. For example, the energy applicator 30 may be an ultrasonic vibrator which assists purification by dispersing agglomerated portions of the sample through agitation. The energy applicator may be used continuously or intermittently throughout the purification process.

When the desired portion of the sample is that which is soluble, it is collected in the solvent flask 2 together with solvent. In such a case, the solvent flask can be disconnected from the extraction tube, the solvent evaporated, and the desired portion of the sample easily is collected. Further, the undissolved portions of the sample, which may be either wanted or unwanted, are then collected in the filter 10. When the desired portion of the sample is that which has not been dissolved, such is retained in the filter 10, and easily is removed.

Next, a purification process for obtaining carbon nanotubes, and in particular SWNTs, will be described. In order to carry out a one-step purification of SWNTs, the reflux system of the present invention according to an embodiment combines the functions of ultrasound agitation, low temperature oxidation, and instant filtration.

First, a soot sample to be purified is placed in the filter 10 which, in turn, is disposed within the extraction tube 7. The soot sample contains the desired carbon nanostructures—SWNTs in this example—along with one or more of the following: amorphous carbon; metal catalyst particles; fullerenes; and other carbon nanoparticles. A solvent, for removing oxidized amorphous carbon from the sample, is disposed in the solvent flask 2 wherein it is heated so as to evaporate. In this example, a solvent having a dipole moment larger than one is used to assist in dispersing agglomerations in the soot and so as to easily dissolve and loosen oxidized amorphous carbon. Preferably, the dipole moment of the solvent is in the range of from greater than or equal to about 1, to about 4. Examples of solvent which may be used include water (H₂O), DMSO, dimethylformamide (DMF), THF, the like and suitable combinations thereof.

The evaporated solvent enters evaporation tube 5, and then travels through the evaporation tube 5, along the direction of arrow A, so as to enter the vapor chamber 9. In order to assist in driving the evaporated solvent through the evaporation tube 5, gas may be pumped through the flask inlet 3. For example, the gas pumped through the flask inlet 3 may be air or oxygen. After driving the evaporated solvent to the evaporation chamber 9 and, subsequently, to the condenser tube 21, the gas is allowed to exit through the condenser-tube gas outlet 23, although some gas may remain in the extraction tube 7. In either case, when oxygen is used, it assists in oxidizing amorphous carbon.

Solvent vapor from vapor chamber 9 enters the condenser-tube inlet 22 and passes up through the condenser tube 21, wherein it is condensed. The solvent condensate then falls back through the condenser-tube inlet 22 and down onto the filter 10 disposed in the extraction tube 7.

In order to oxidize the amorphous carbon portion of the sample, an oxidizing agent—such as oxidizing gases, for example, oxygen (O₂) or ozone (O₃), or oxidizing liquids, for example, H₂O₂—is introduced into the extraction tube 7 through supply tube 13. The gasses flow up through the filter 10 and through the sample contained therein to oxidize the amorphous carbon. The oxidizing agent may be continuously or intermittently introduced to the extraction tube. The oxidized amorphous carbon is then carried with the solvent through the siphon tube 11 and into the solvent flask 2, as described below. Any unused portion of the oxidizing gasses, which were introduced through the supply tube 13, are allowed to exit through the condenser-tube gas outlet 23. Because oxidizing gases are introduced into the extraction tube 7, and to the sample in filter 10, heat is not necessary to oxidize the amorphous carbon. That is, the purification process of the present invention can be carried out at low temperatures such as, for example, ambient or room temperature. By carrying out the purification process at ambient temperature, the SWNTs and other carbon nanostructures are not damaged, or destroyed, as they are at high temperatures. Further, although oxidizing gas has been disclosed, an oxidizing liquid such as H₂O₂ may be used. However, oxidizing gas is preferred because the oxidizing liquid takes up more volume in the extraction tube and, therefore, there is less volume available for the solvent.

In order to remove the metal catalyst portions of the sample, acid vapor is introduced into the extraction tube 7 through the supply tube 13. The acid vapor may be introduced along with the oxidizing gasses, or may be introduced either before or after the oxidizing gasses. As the acid vapor enters the extraction tube 7 and, thus, the soot sample in filter 10, it reacts with the metal particles in the sample thereby forming metal salts. The type of acid used depends on the solvent used. Acid may be contained in the solvent and, thus, may be disposed in the solvent flask 2. That is, if only the acid and the solvent can co-evaporate, they may be disposed in the solvent flask 2, evaporated, and condensed together. Introducing the acid and solvent together is preferable, as long as the acid does not have a tendency to react with, or decompose in, the solvent vapor which may be hot. In still another embodiment, the acid may be introduced as vapor through the flask inlet 3 and, thereby, also may be used to assist in driving solvent vapor through the vapor tube 5. Each of the above three manners of introducing acid to the extraction tube may be used either separately, or in combination with one or more of the other manners of introducing acid to the extraction tube. Further, the acid may be continuously, or intermittently, introduced.

To further assist with separating the desired portion of the sample from the impurities, the energy applicator 30 may be used to apply energy to the sample contained in filter 10. For example, the energy applicator 30 may be an ultrasonic vibrator which assists purification by dispersing agglomerated portions of the sample, which agglomerations include amorphous carbon, metal catalyst particles, and the desired SWNTs. For example, ultrasonic vibration of about 100 W to about 1000 W, preferably about 350 W to about 500 W, can be applied to the soot sample. By dispersing the agglomerations, the solvent, and acid vapor, readily can react with more of the sample and, thus, a higher purity can be achieved. That is, because the agglomerations are dispersed into smaller particles, a greater surface area is available for the solvent, oxidizing agent, and acid. The energy applicator 30 may be operated continuously, or intermittently, throughout the purification process.

The solvent condensate, received from the condenser, collects in the extraction tube 7 and enters the filter 10 so as to dissolve the oxidized amorphous carbon portion of the sample. The solvent also washes out of the sample any fullerenes that are present. When the solvent level in the extraction tube 7 rises above the highest portion of the siphon tube 11, the solvent then flows through the siphon tube 11, in the direction of arrow B, back down into the solvent flask 2 carrying the oxidized amorphous carbon, and metal salt, portions of the sample with it. Because the siphon tube 11 is connected to the bottom portion 7″ of the extraction tube 7, substantially all of the solvent—including the oxidized amorphous carbon, and metal salt, portions of the sample contained therein—are removed from the extraction tube 7.

The evaporation process is again carried out as necessary, so that the oxidized amorphous portion of the sample is collected in the solvent flask 2. That is, the temperature of the thermal mantle is selected so that only the solvent and acid are evaporated from the solvent flask 2, leaving the amorphous carbon, metal salts, and fullerenes in the solvent flask 2. What is left in the solvent flask 2, however, depends on what was included in the soot sample first placed in filter 10. That is, if no fullerenes were present in the original soot sample, then none will be present in the solvent flask 2. Similarly, if there were no metal catalyst particles in the original soot sample, then there will be no metal salts in the solvent flask 2. But if there were fullerenes in the original soot sample, they are collected in the solvent flask 2 and easily may be extracted therefrom. That is, the apparatus can purify a sample containing both carbon nanotubes and fullerenes, and can do so such that both structures are purified at the same time. When purifying carbon nanotubes and fullerenes at the same time, it is preferable to first use a solvent with a dipole less than about 1, before introducing an oxidizing agent to the sample, to increase the yield of fullerenes which may be damaged by the oxidizing agent.

In order to retain the desired SWNTs in the filter 10, a filter having a pore size of less than about 1 μm is used. Such pore size allows fullerenes, but not nanotubes, to pass therethrough. Additionally, the filter may be made of any material that will withstand attack from the acid introduced to remove the metal catalyst particles. For example, the filter may be made of Teflon, or paper fiber which is stable in an acid environment. Further, preferably, the filter 10 is one which encloses, or envelopes, the soot sample so that no carbon nanotubes are washed out when the solvent is removed from the extraction tube 7.

Thus, in the above one-step purification process, the desired SWNTs are filtered and left in the filter 10, whereas any fullerenes are extracted and are present in the solvent flask 2. The process is a one-step process in that the soot sample, and/or intermediate products therefrom, do not need to be removed from one apparatus until purification of the desired carbon nanostructures contained in sample is complete.

The above described method, for purifying SWNTs, may also be used to purify MWNTs, or any other carbon nanotubes or nano-fibers. All that is necessary to purify these other structures is to have them in the original soot sample which is placed in the filter 10. That is, if the original soot sample contains MWNTs, such structures will be collected in the filter 10, whereas fullerenes, amorphous carbon, and metal salts will be collected in solvent flask 2. Similarly, if the original soot sample contains other carbon nanotubes, or nano-fibers, these structures will be purified and collected in the filter 10. However, at present, the filter 10 does not distinguish between SWNTs, MWNTs, other nanotubes, or other nano-fibers. Therefore, any of such structures which are present in the original soot sample will be collected in the filter 10.

In one example of the above-described process for purifying SWNTs according to an embodiment of the present invention, water was used for the solvent, and HNO₃ was used as the acid. The acid was mixed with the water in the solvent flask 2 before heating it. The water and HNO₃ were then evaporated together, and condensed together. Oxygen gas was continuously introduced through flask inlet 3 at about 50 ml/min to assist in driving the solvent and acid vapor through the vapor tube 5. Also, a flow of oxygen gas containing about 2% of ozone was introduced to the extraction tube 7 through supply tube 13 at about 50 ml/min. Thus, the oxidizing agent for this example includes oxygen and ozone gasses, wherein the content of ozone was limited to about 2% of the gas introduced through supply tube 13 because if the concentration of ozone is too high, it may destroy the SWNTs. The energy applicator was an ultrasonic vibrator operated at 350 W, and was operated continuously throughout the purification process. All of the previously described conditions—heating and vapor condensation of both H₂O and HNO₃ together, introduction of gasses through both flask inlet 3 and supply tube 13, and ultrasonic vibration—were carried out simultaneously. For a 10 g soot sample, produced by an arc-discharge operation, containing at least SWNTs, amorphous carbon, metal catalyst particles, and a trace amount of fullerenes, the above process was carried out under the previously described conditions for about 3 to about 4 hours, and resulted in a 95 wt % yield of SWNTs having a purity of 95%. This yield, at such a high purity of SWNTs, is believed to be greater than has been achieved as compared to known processes, thus exemplifying the advantages of the present invention. Although specific process parameters have been given here, they are not intended to be limiting to the scope of the present invention. For example, these parameters may be varied in accordance with the guidance given throughout the specification.

The present invention in an embodiment is also applicable to the extraction of fullerenes. That is, the apparatus and method of the present invention in an embodiment may be used to purify an original soot sample mainly containing fullerenes as the desired product. In such a case, the above-described apparatus is used in the above-described manner, except that: no oxidizing gasses are introduced; no acid vapor is introduced; an inert gas may be used to drive the solvent vapor through the vapor tube 5; the extraction tube has an inert gas environment; and a solvent having a dipole less than about 1 is used pursuant to an embodiment of the present invention. Such solvents include, for example, CS₂, toluene, benzene the like, and suitable combinations thereof. By using a solvent with a dipole less than about 1, the solvent readily extracts the fullerenes from the sample while leaving the amorphous carbon and metallic particles in the filter. Further, because the amorphous carbon is not oxidized, and because the metal catalyst particles are not reacted with acid, such products are contained in the filter 10 along with any carbon nanotubes that were present in the original soot sample. Thus, only the solvent and fullerenes are collected in the solvent flask 2 thereby making it easy to collect the desired fullerenes.

It is contemplated that numerous modifications may be made to the reflux system and purification method of the present invention without departing from the spirit and scope of the invention as defined in the claims. For example, although the reflux system was described as being used to purify carbon nanostructures, it can be used in the same manner as a traditional SOXLET extractor to purify, or extract, any desired substance from a given sample.

Because the process is carried out at ambient temperature, with little or no heating of the soot sample, SWNTs are not damaged or destroyed thereby producing an increased yield of SWNTs. Additionally, because the process in an embodiment is carried out in one apparatus—i.e., it is a one-step process—it can be done quickly, at a reduced cost, with reduced risk of contaminating or damaging the sample. Further, the apparatus systems and method of the present invention are capable of efficiently purifying large amounts of low-purity soot to a high degree with a high yield of the desired carbon nanostructures. Moreover, the present invention in an embodiment can be used easily to purify carbon nanotubes, fullerenes, or other suitable substances.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

### Description of Reference Numerals

1 extractor
2 solvent flask
3 flask inlet
4 thermal mantle
5 vapor tube
6 vapor-tube insulation
7 extraction tube
7′ top portion of extraction tube
7″ bottom portion of extraction tube
8 stopper
9 vapor chamber
10 filter
11 siphon tube
12 spacers
13 supply tube
20 condenser
21 condenser tube
22 condenser-tube inlet
23 condenser-tube gas outlet
24 cooling-fluid jacket
25 cooling-fluid inlet
26 cooling-fluid outlet
30 energy applicator

1-31. (canceled)

32. A reflux system comprising:
a solvent supply device;
an extraction tube connected to the solvent supply device, wherein the extraction tube has a top portion and a bottom portion;
a siphon tube extending from the bottom portion of the extraction tube, and connected to the solvent source; and
an energy applicator disposed around the bottom portion of the extraction tube.

33. The reflux system according to claim 32, wherein the solvent supply device is a solvent flask, and the reflux system further comprises a vapor tube connected between the solvent flask and the extraction tube.

34. The reflux system according to claim 33, further comprising a condenser connected to the top portion of the extraction tube.

35. The reflux system according to claim 33, further comprising a supply tube connected to the extraction tube through which material can be introduced into the extraction tube.

36. The reflux system according to claim 32, wherein the energy applicator is an ultrasonic vibrator.

37. A reflux system comprising:
a solvent source including a solvent flask and a vapor tube connected to the solvent flask;
an extraction tube having a top portion and a bottom portion, wherein the extraction tube is connected to the vapor tube allowing the extraction tube to be in communication with the solvent flask;
a condenser connected to the top portion of the extraction tube, wherein the condenser is in communication with the vapor tube;
a siphon tube extending from the bottom portion of the extraction tube, and connected to the solvent flask; and
a supply tube connected to the extraction tube through which material can be introduced into the extraction tube.

38. The reflux system according to claim 37, further comprising an energy applicator disposed around the bottom portion of the extraction tube.

39. The reflux system according to claim 38, wherein the energy applicator is an ultrasonic vibrator.

40. A one-step method of purifying carbon nanotubes, comprising:
placing a soot sample that contains the carbon nanotubes together with amorphous carbon in a filter and disposing the filter in a lower portion of an extraction tube;
introducing an oxidizing agent into the extraction tube to oxidize the amorphous carbon;
introducing a solvent into the extraction tube so as to contact the filter, collect in the lower portion of the extraction tube, and dissolve the oxidized amorphous carbon from the soot sample; and
removing the solvent from the extraction tube allowing the carbon nanotubes to remain in the filter, wherein the method of purifying carbon nanotubes is carried out at ambient temperature.

41. The method according to claim 40, wherein the soot sample includes metal catalyst particles, and the method further comprises introducing acid into the extraction tube allowing the acid to remove the metal catalyst particles from the soot sample.

42. The method according to claim 41, wherein the step of introducing an oxidizing agent includes introducing oxidizing gas, the step of introducing acid into the extraction tube includes introducing acid vapor, and further wherein the acid vapor is simultaneously introduced with the oxidizing gas.

43. The method according to claim 41, wherein the step of introducing solvent includes introducing solvent vapor to the extraction tube and condensing the solvent vapor, and wherein the step of introducing acid into the extraction tube includes introducing acid vapor along with the solvent vapor.

44. The method according to claim 40, further comprising applying energy to the soot sample so as to disperse agglomerations.

45. The method according to claim 44, wherein the energy is ultrasonic vibration.

46. The method according to claim 45, wherein the step of applying energy is performed simultaneously with the step of introducing an oxidizing agent and simultaneously with the step of introducing solvent.

47. The method according to claim 40, wherein the solvent has a dipole greater than or equal to about 1.

48. A one-step method of purifying carbon nanostructures, comprising:
placing a soot sample that contains the carbon nanostructures in combination with amorphous carbon in a filter and disposing the filter in a lower portion of an extraction tube;
introducing solvent into the extraction tube so as to contact the filter, collect in the lower portion of the extraction tube, and dissolve one of the amorphous carbon and the carbon nanostructures from the soot sample;
applying energy to the soot sample in the extraction tube so as to disperse agglomerations; and
removing the solvent, and the one of the amorphous carbon and carbon nanostructures dissolved therein, from the extraction tube so that the other one of the amorphous carbon and the carbon nanostructures remains in the filter.

49. The method according to claim 48, wherein the step of applying energy includes applying ultrasonic vibration.

50. The method according to claim 48, further comprising carrying out the method of purifying carbon nanostructures at ambient temperature.

51. The method according to claim 48, further comprising introducing an oxidizing agent into the extraction tube to oxidize the amorphous carbon.

52. The method according to claim 51, wherein the step of introducing solvent includes introducing a solvent having a dipole greater than or equal to about 1 so that the carbon nanostructures remain in the filter, whereas the oxidized amorphous carbon is dissolved in the solvent.

53. The method according to claim 51, further comprising introducing acid into the extraction tube to remove metallic particles from the soot sample.

54. The method according to claim 53, wherein the step of introducing an oxidizing agent includes introducing an oxidizing gas, wherein the step of introducing acid into the extraction tube includes introducing acid vapor, and wherein the acid vapor is introduced simultaneously with the oxidizing gas.

55. The method according to claim 53, wherein the step of introducing solvent to the extraction tube includes introducing solvent vapor into the extraction tube and condensing the solvent vapor, and wherein the step of introducing acid into the extraction tube includes introducing acid vapor along with the solvent vapor.

56. The method according to claim 48, wherein the step of introducing solvent includes introducing a solvent having a dipole less than about 1, so that the carbon nanostructures are dispersed in the solvent, whereas the amorphous carbon remains in the filter.

57. The method according to claim 56, wherein the step of introducing solvent includes introducing solvent vapor with an inert gas, and then condensing the solvent vapor.

58. A one-step method of purifying carbon fullerenes, comprising:
placing a soot sample that contains the carbon fullerenes together with amorphous carbon in a filter and disposing the filter in a lower portion of an extraction tube;
introducing a solvent into the extraction tube so as to contact the filter, collect in the lower portion of the extraction tube, and form a solution with the fullerenes from the soot sample, wherein the solvent has a dipole moment less than about 1; and
removing the solvent containing the fullerenes from the extraction tube so that the amorphous carbon remains in the filter, wherein the above steps are carried out at ambient temperature.

59. The method according to claim 58, further comprising applying ultrasonic energy to the soot sample so as to disperse agglomerations.

60. The method according to claim 59, wherein the step of applying energy is performed simultaneously with the step of introducing solvent.

61. The method according to claim 58, wherein the step of introducing solvent includes evaporating the solvent from a flask, causing the solvent to travel along an evaporation tube to a condenser, and condensing the evaporated solvent in the condenser so that the solvent is introduced to the extraction tube, and wherein the step of removing the solvent includes returning the solvent to the flask.

62. The method according to claim 61, wherein the step of introducing solvent includes using an inert gas to assist in causing the evaporated solvent to travel along an evaporation tube, and further comprising maintaining an atmosphere, in the extraction tube, without oxidizing agents.
